(19) United States
(12) Patent Application Publication
(10) Pub. No.: US 2026/0288713 A1
(43) Pub. Date: Sep. 24, 2026

(54) SYSTEM AND METHOD FOR HYBRID QUERY ORCHESTRATION FOR COMPLEX QUERIES

(71) Applicant: Tata Consultancy Services Limited, Mumbai (IN)

(72) Inventors: Shruti Kunal KUNDE, Mumbai (IN); Mayank MISHRA, Thane (IN); Ravi Kumar SINGH, Mumbai (IN); Kuldeep SINGH, Mumbai (IN); Manoj Karunakaran NAMBIAR, Mumbai (IN); Rekha SINGHAL, New York, NY (US)

(73) Assignee: Tata Consultancy Services Limited, Mumbai (IN)

(21) Appl. No.: 19/546,583

(22) Filed: Feb. 23, 2026

(30) Foreign Application Priority Data
Mar. 18, 2025 (IN) 202521024138

(51) Int. Cl. G06F 16/2452; G06F 16/2453; G06F 16/248

(52) U.S. Cl. CPC G06F 16/24522; G06F 16/24535; G06F 16/248

(57) ABSTRACT

Existing systems face challenges of efficiently handling complex, multi-source queries in enterprise applications. The present disclosure generates a response to the user's Natural Query Language (NLQ) by decomposing the NLQ into sub-queries. Sub-queries related to database are converted into SQL queries and sub-queries related to policy documents are processed using Graph RAG. The data retrieved from database and policy contexts are combined and sent along with NLQ to LLM, which generates the response. On the other hand, the NLQ is sent to Graph RAG for retrieving context, which is combined with database schema, and passed to LLM to assess whether additional database context is required. If needed, LLM generates SQL query which is executed to fetch data. The retrieved database context, Graph RAG context along with NLQ are sent to LLM to generate the response.

### PRIORITY CLAIM

This U.S. patent application claims priority under 35 U.S.C. § 119 to: India Application No. 202521024138, filed on Mar. 18, 2025. The entire contents of the aforementioned application are incorporated herein by reference.

### TECHNICAL FIELD

The disclosure herein generally relates to query orchestration, and, more particularly, to a system and method for hybrid query orchestration for complex queries.

### BACKGROUND

Large Language Models (LLMs) have become increasingly integral to the operations of many industries, especially where the ability to process vast amount of data and perform complex reasoning tasks is paramount. One such area is customer support, particularly through chatbot applications that handle user queries in natural language. However, many of these queries are not as straightforward and often involve multiple, interdependent steps. For example, consider a banking application where a customer wants to check their eligibility for a home loan. They might ask, “Am I eligible for a home loan based on my income and credit history? What is the interest rate applicable to me?” While this query appears simple on the surface, addressing it involves several layers of complexity. The chatbot must first assess the customer's eligibility by evaluating structured data from an SQL database-such as the customer's income, outstanding loans, and credit score. Simultaneously, the interest rate calculation may require querying a NoSQL (known in the art) database that contains unstructured, dynamic data like current interest rates, loan offers, or personalized terms. Additionally, in certain cases, external data sources may be accessed to verify credit history or gather real-time information about market conditions, further complicating the process.

Natural language queries in high-traffic settings like banking require sophisticated orchestration across structured and unstructured data. Current chatbots heavily rely on LLMs for both reasoning and data retrieval, which is costly and inefficient for complex queries. Recent research explores LLMs' capabilities in handling such queries, but their monolithic approach leads to significant computational expenses and latency issues, particularly in complex scenarios and involve multiple layers of reasoning.

### SUMMARY

Embodiments of the present disclosure present technological improvements as solutions to one or more of the above-mentioned technical problems recognized by the inventors in conventional systems. For example, in one embodiment, a method for hybrid query orchestration for complex queries is provided. The method includes receiving, via one or more hardware processors, an input comprising (i) one or more natural language queries (NLQ) from a user; and (ii) one or more database schema contexts associated with the one or more NLQ from one or more structured data sources and one or more unstructured data sources; generating, via the one or more hardware processors, a prompt using the received input; decomposing, via the one or more hardware processors, the received one or more NLQ into one or more subqueries by sending the generated prompt to one or more Large Language Models (LLMs); converting, via the one or more hardware processors, the one or more subqueries into a first set of Structured Query Language (SQL) queries, if the one or more subqueries contain information specific to a database; converting, via the one or more hardware processors, the one or more subqueries into a first set of subqueries, if the one or more subqueries contain information specific to one or more documents; retrieving, via the one or more hardware processors, a first set of data pertaining to the first set of SQL queries comprised in the database by executing the first set of SQL queries on the database; retrieving, via the one or more hardware processors, a context pertaining to the first set of subqueries, by executing the first set of subqueries on a Graph RAG (Retrieval Augmented Generation); combining, via the one or more hardware processors, (i) the retrieved first set of data pertaining to the first set of SQL queries, (ii) the retrieved context pertaining to the first set of subqueries along with the received one or more NLQ; and generating, via the one or more hardware processors, a response for the user by sending the combined data comprising (i) the retrieved first set of data pertaining to the first set of SQL queries, (ii) the retrieved context pertaining to the first set of subqueries along with the received one or more NLQ to the one or more LLMs.

In another aspect, there is provided a system for hybrid query orchestration for complex queries. The system comprises: a memory storing instructions; one or more communication interfaces; and one or more hardware processors coupled to the memory via the one or more communication interfaces, wherein the one or more hardware processors are configured by the instructions to: receive an input comprising (i) one or more natural language queries (NLQ) from a user; and (ii) one or more database schema contexts associated with the one or more NLQ from one or more structured data sources and one or more unstructured data sources. The system further includes generating a prompt using the received input; decomposing the received one or more NLQ into one or more subqueries by sending the generated prompt to one or more Large Language Models (LLMs); converting the one or more subqueries into a first set of Structured Query Language (SQL) queries, if the one or more subqueries contain information specific to a database; converting the one or more subqueries into a first set of subqueries, if the one or more subqueries contain information specific to one or more documents; retrieving a first set of data pertaining to the first set of SQL queries comprised in the database by executing the first set of SQL queries on the database; retrieving a context pertaining to the first set of subqueries, by executing the first set of subqueries on a Graph RAG (Retrieval Augmented Generation); combining (i) the retrieved first set of data pertaining to the first set of SQL queries, (ii) the retrieved context pertaining to the first set of subqueries along with the received one or more NLQ; and generating a response for the user by sending the combined data comprising (i) the retrieved first set of data pertaining to the first set of SQL queries, (ii) the retrieved context pertaining to the first set of subqueries along with the received one or more NLQ to the one or more LLMs.

In yet another aspect, there are provided one or more non-transitory machine-readable information storage mediums comprising one or more instructions which when executed by one or more hardware processors cause receiving an input comprising (i) one or more natural language queries (NLQ) from a user; and (ii) one or more database schema contexts associated with the one or more NLQ from one or more structured data sources and one or more unstructured data sources; generating a prompt using the received input; decomposing the received one or more NLQ into one or more subqueries by sending the generated prompt to one or more Large Language Models (LLMs); converting the one or more subqueries into a first set of Structured Query Language (SQL) queries, if the one or more subqueries contain information specific to a database; converting the one or more subqueries into a first set of subqueries, if the one or more subqueries contain information specific to one or more documents; retrieving a first set of data pertaining to the first set of SQL queries comprised in the database by executing the first set of SQL queries on the database; retrieving a context pertaining to the first set of subqueries, by executing the first set of subqueries on a Graph RAG (Retrieval Augmented Generation); combining (i) the retrieved first set of data pertaining to the first set of SQL queries, (ii) the retrieved context pertaining to the first set of subqueries along with the received one or more NLQ; and generating a response for the user by sending the combined data comprising (i) the retrieved first set of data pertaining to the first set of SQL queries, (ii) the retrieved context pertaining to the first set of subqueries along with the received one or more NLQ to the one or more LLMs.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary system for hybrid query orchestration for complex queries, according to some embodiments of the present disclosure.

FIG. 2 is a functional block diagram of the system for hybrid query orchestration for complex queries, according to some embodiments of the present disclosure.

FIGS. 3A and 3B are flow diagrams illustrating the steps involved in the method for hybrid query orchestration for complex queries, according to some embodiments of the present disclosure.

FIG. 4 is a block diagram illustrating a context latent approach, in conjunction with the method for hybrid query orchestration for complex queries, according to some embodiments of the present disclosure.

FIG. 5 is a block diagram illustrating a context acute approach, in conjunction with the method for hybrid query orchestration for complex queries, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

LLMs have revolutionized natural language processing, particularly in chatbots and customer service systems, by generating human-like responses. Early rule-based systems struggled with complex queries, but LLMs improved reasoning and the handling of intricate tasks. However, relying solely on LLMs for all reasoning incurs substantial computational costs. Retrieval-Augmented Generation (RAG) mitigates this by integrating external information retrieval with LLMs to generate contextually accurate responses (known in the art). Graph-based RAG further enhances this by organizing retrieved data into graphs, improving semantic reasoning and decision-making. Despite these advances, RAG and other retrieval-augmented models often remain computationally expensive due to the use of large-scale embeddings and vector search techniques (known in the art). Efforts to reduce these costs include hybrid retrieval approaches (known in the art) and optimized information flow methods (known in the art), which balance efficiency with response quality. However, these systems still struggle with complex, multi-domain queries or scaling for real-time applications. Research has also explored graph databases for knowledge retrieval, such as Neo4j (known in the art), which structures data to support efficient search and reasoning. Yet, combining graph-based approaches with LLMs remains a challenge, particularly in terms of cost-effectiveness and scalability.

Retrieval-Augmented Generation (RAG) (known in the art) combines traditional vector-based retrieval methods with large language model (LLM)-based generation to enhance complex query answering by pulling relevant information from knowledge stores before generating a response. However, most RAG-based systems face scalability, cost-efficiency, and query orchestration challenges, particularly in domains such as banking, where a variety of data sources need to be accessed and integrated.

### Core Challenges:

(1) Data Heterogeneity: Queries in sectors like banking span diverse data sources (SQL, NoSQL, web-based), each needing different retrieval methods. Integrating these into a single pipeline is complex; relying on LLMs for both retrieval and reasoning is inefficient.
(2) Cost: LLMs are resource-intensive, costly for large-scale operations. In sectors like banking, where query accuracy and speed are crucial, minimizing LLM use for retrieval while maintaining reasoning for complex tasks is essential for cost-efficiency.
(3) Query Complexity: Complex queries (e.g., home loan eligibility) involve multiple steps (eligibility checks, real-time rates, structured/unstructured data). Decomposing these queries and orchestrating accurate sub-queries across diverse sources is intricate, requiring context-aware data access.

Addressing these challenges is critical for businesses aiming to deliver fast, reliable, and personalized responses to complex queries while controlling costs. To remain competitive in sectors like banking, efficiently orchestrating queries across diverse data sources without over-relying on expensive LLM computation is key.

The present disclosure addresses the above-mentioned challenges of efficiently handling complex, multi-source queries in enterprise applications by proposing a system and method for hybrid query orchestration for complex queries. The present disclosure generates a prompt using an input comprising (i) one or more natural language queries (NLQ) from a user; and (ii) one or more database schema contexts associated with the one or more NLQ from one or more structured data sources and one or more unstructured data sources. The received one or more NLQ is decomposed into one or more subqueries by sending the generated prompt to one or more Large Language Models (LLMs). The one or more subqueries are converted into a first set of Structured Query Language (SQL) queries, if the one or more subqueries contain information specific to a database. The one or more subqueries are converted into a first set of subqueries, if the one or more subqueries contain information specific to one or more documents. A first set of data pertaining to the first set of SQL queries is retrieved by executing the first set of SQL queries on the database. A context pertaining to the first set of subqueries is retrieved, by executing the first set of subqueries on a Graph RAG (Retrieval Augmented Generation). The present disclosure further combines (i) the retrieved first set of data pertaining to the first set of SQL queries, (ii) the retrieved context pertaining to the first set of subqueries along with the received one or more NLQ. Furthermore, a response for the user is generated by sending the combined data comprising (i) the retrieved first set of data pertaining to the first set of SQL queries, (ii) the retrieved context pertaining to the first set of subqueries along with the received one or more NLQ to the one or more LLMs.

Furthermore, the context pertaining to the one or more documents is retrieved using the Graph RAG (Retrieval Augmented Generation). The retrieved context specific to the one or more documents along with the database schema context is sent to the LLM to check whether an additional database context is required. The present disclosure further generates a second set of SQL queries by the LLM, if the additional database context is required. The second set of data is retrieved from the database by executing the generated second set of SQL queries. The present disclosure further combines (i) the retrieved context pertaining to the one or more documents (ii) the retrieved context pertaining to the first set of subqueries along with the received one or more NLQ. The response to the user is generated by sending the combined data comprising (i) the retrieved context pertaining to the one or more documents (ii) the retrieved context pertaining to the first set of subqueries along with the received one or more NLQ.

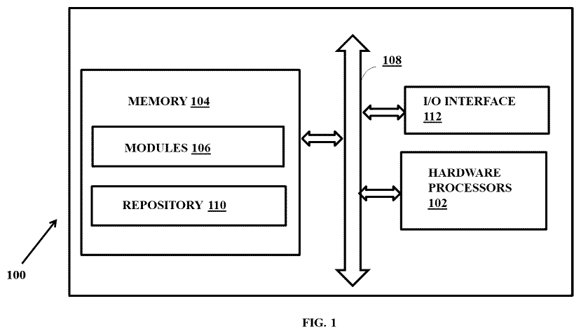

Referring now to the drawings, and more particularly to FIG. 1 through FIG. 5, where similar reference characters denote corresponding features consistently throughout the figures, there are shown preferred embodiments, and these embodiments are described in the context of the following exemplary system and/or method.

FIG. 1 illustrates an exemplary system for hybrid query orchestration for complex queries, according to some embodiments of the present disclosure. In an embodiment, the system 100 includes or is otherwise in communication with hardware processors 102, at least one memory such as a memory 104, and an I/O interface 112. The hardware processors 102, memory 104, and the Input/Output (I/O) interface 112 may be coupled by a system bus such as a system bus 108 or a similar mechanism. In an embodiment, the hardware processors 102 can be one or more hardware processors.

The I/O interface 112 may include a variety of software and hardware interfaces, for example, a web interface, a graphical user interface, and the like. The I/O interface 112 may include a variety of software and hardware interfaces, for example, interfaces for peripheral device(s), such as a keyboard, a mouse, an external memory, a printer and the like. Further, the I/O interface 112 may enable the system 100 to communicate with other devices, such as web servers, and external databases.

The I/O interface 112 can facilitate multiple communications within a wide variety of networks and protocol types, including wired networks, for example, local area network (LAN), cable, etc., and wireless networks, such as Wireless LAN (WLAN), cellular, or satellite. For this purpose, the I/O interface 112 may include one or more ports for connecting several computing systems with one another or to another server computer. The I/O interface 112 may include one or more ports for connecting several devices to one another or to another server.

The one or more hardware processors 102 may be implemented as one or more microprocessors, microcomputers, microcontrollers, digital signal processors, central processing units, node machines, logic circuitries, and/or any devices that manipulate signals based on operational instructions. Among other capabilities, the one or more hardware processors 102 is configured to fetch and execute computer-readable instructions stored in memory 104.

The memory 104 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. In an embodiment, the memory 104 includes a plurality of modules 106. The memory 104 also includes a data repository (or repository) 110 for storing data processed, received, and generated by the plurality of modules 106.

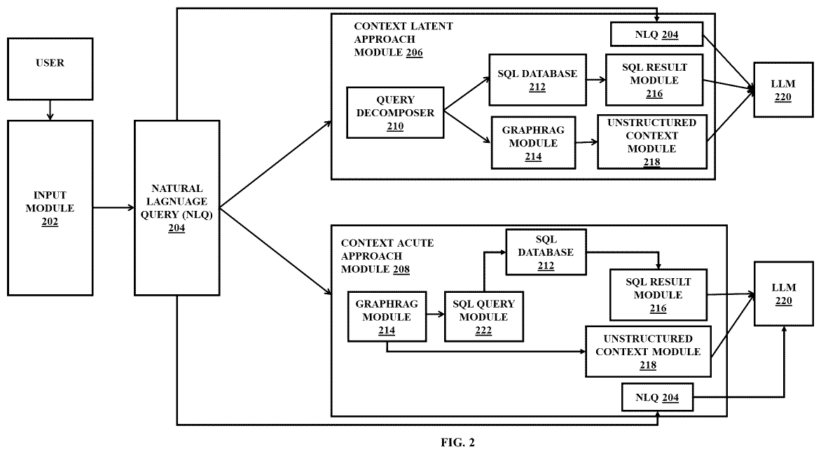

The plurality of modules 106 includes programs or coded instructions that supplement applications or functions performed by the system 100 for hybrid query orchestration for complex queries. The plurality of modules 106, amongst other things, can include routines, programs, objects, components, and data structures, which perform particular tasks or implement particular abstract data types. The plurality of modules 106 may also be used as signal processor(s), node machine(s), logic circuitries, and/or any other device or component that manipulates signals based on operational instructions. Further, the plurality of modules 106 can be used by hardware, by computer-readable instructions executed by the one or more hardware processors 102, or by a combination thereof. The plurality of modules 106 can include various sub-modules (not shown). The plurality of modules 106 may include computer-readable instructions that supplement applications or functions performed by the system 100 for hybrid query orchestration for complex queries. In an embodiment, the modules 106 include an input module 202, a natural language query 204, a context latent approach module 206, a context acute approach module 208 and a LLM 220. The context latent approach module 206 includes a query decomposer 210, an SQL database 212, a Graph RAG module 214, a SQL result module 216, and an unstructured context module 218. The context acute approach module 208 includes a SQL query module 222. The modules are depicted in FIG. 2. These modules that are depicted in FIG. 2 are implemented as at least one of a logically self-contained part of a software program, a self-contained hardware component, and/or a self-contained hardware component with a logically self-contained part of a software program embedded into each of the hardware component that when executed perform the above method described herein, in one embodiment of the present disclosure.

The data repository (or repository) 110 may include a plurality of abstracted pieces of code for refinement and data that is processed, received, or generated as a result of the execution of the module(s) 106.

Although the data repository 110 is shown internal to the system 100, it will be noted that, in alternate embodiments, the data repository 110 can also be implemented external to the system 100. The data contained within such an external database may be periodically updated. For example, new data may be added into the database (not shown in FIG. 1) and/or existing data may be modified and/or non-useful data may be deleted from the database. In one example, the data may be stored in an external system, such as a Lightweight Directory Access Protocol (LDAP) directory and a Relational Database Management System (RDBMS).

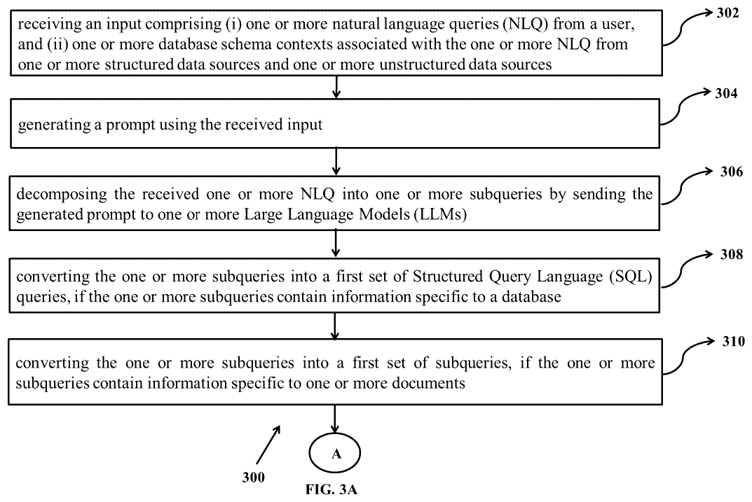

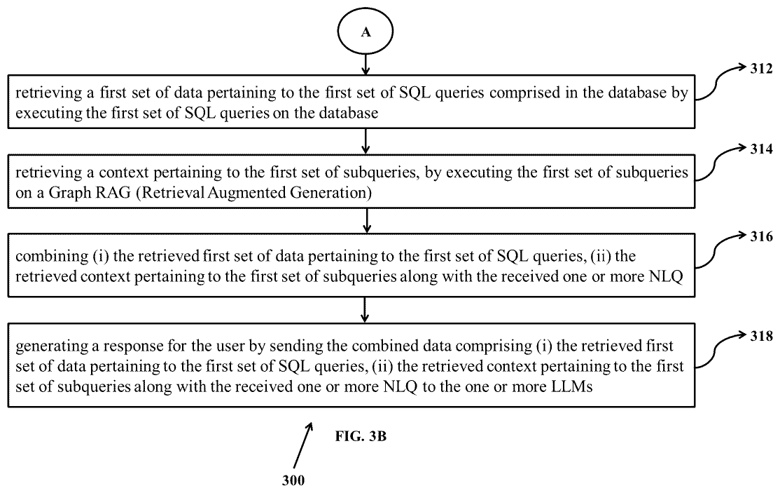

FIGS. 3A and 3B are flow diagrams illustrating a method for hybrid query orchestration for complex queries using the systems 100 of FIGS. 1-2, according to some embodiments of the present disclosure. Steps of the method of FIGS. 3A and 3B shall be described in conjunction with the components of FIG. 2. At step 302 of the method 300, the input module 202 and the natural language query (NLQ) 204 executed by the one or more hardware processors 102 receives an input comprising (i) one or more natural language queries (NLQ) from a user; and (ii) one or more database schema contexts associated with the one or more NLQ from one or more structured data sources and one or more unstructured data sources. The one or more structured data sources comprise at least one of one or more databases storing customer information and one or more transaction details. The one or more unstructured data sources comprise the one or more documents which are stored in a Portable Document Format (PDF) format.

At step 304 of the method 300, the input module 202 and the natural language query (NLQ) 204 executed by the one or more hardware processors 102 generate a prompt using the received input.

At step 306 of the method 300, the natural language query (NLQ) module 204 and the query decomposer 210 of the context latent approach module 206 executed by the one or more hardware processors 102 decompose the received one or more NLQ into one or more subqueries by sending the generated prompt to one or more Large Language Models (LLMs).

At step 308 of the method 300, the SQL database 212 of the context latent approach module 206 executed by the one or more hardware processors 102 converts the one or more subqueries into a first set of Structured Query Language (SQL) queries, if the one or more subqueries contain information specific to a database.

At step 310 of the method 300, the Graph RAG module 214 of the context latent approach module 206 executed by the one or more hardware processors 102 convert the one or more subqueries into a first set of subqueries, if the one or more subqueries contain information specific to one or more documents. The one or more documents comprise policy related information specific to a financial institution stored in an unstructured format.

At step 312 of the method 300, the one or more hardware processors 102 retrieve a first set of data pertaining to the first set of SQL queries comprised in the database by executing the first set of SQL queries on the database.

At step 314 of the method 300, the one or more hardware processors 102 retrieve a context pertaining to the first set of subqueries by executing the first set of subqueries on a Graph RAG (Retrieval Augmented Generation).

At step 316 of the method 300, the natural language query (NLQ) module 204, the SQL result module 216 and the unstructured context module 218 of the context latent approach module 206 executed by the one or more hardware processors 102 combines (i) the retrieved first set of data pertaining to the first set of SQL queries, (ii) the retrieved context pertaining to the first set of subqueries along with the received one or more NLQ. It is to be noted that whatever data is retrieved is combined. If there is no relevant data in any one of the steps or both the steps, it means there is no meaningful data pertaining to the query that is asked by the user.

At step 318 of the method 300, the LLM 220 executed by the one or more hardware processors 102 generates a response for the user by sending the combined data comprising (i) the retrieved first set of data pertaining to the first set of SQL queries, (ii) the retrieved context pertaining to the first set of subqueries along with the received one or more NLQ to the one or more LLMs.

In the present disclosure, the context pertaining to the one or more documents is retrieved using the Graph RAG (Retrieval Augmented Generation). The retrieved context specific to the one or more documents along with the database schema context is sent to the LLM to check whether an additional database context is required. A second set of SQL queries (represented by the SQL query module 222) is generated by the LLM, if the additional database context is required. The second set of data is retrieved from the database by executing the generated second set of SQL queries. The present disclosure further combines (i) the retrieved context pertaining to the one or more documents (ii) the retrieved context pertaining to the first set of subqueries along with the received one or more NLQ. The response to the user is generated by sending the combined data comprising (i) the retrieved context pertaining to the one or more documents (ii) the retrieved context pertaining to the first set of subqueries along with the received one or more NLQ.

The Context Latent approach (Algorithm 1) of the present disclosure processes the one or more natural language queries (NLQ) by leveraging both structured and unstructured data sources. The process begins with receiving the NLQ and database schema context, followed by decomposing the query into sub-queries. Sub-queries related to the database are converted into SQL queries, while those concerning policy documents are processed using a Graph RAG similarity search (known in the art). The SQL queries retrieve data from the database, and the policy-related sub-queries yield top-ranked results from the Graph RAG. The retrieved database and policy contexts are then combined and sent along with the original NLQ to an LLM, which generates the final response. This approach ensures comprehensive query processing by integrating structured and unstructured data sources.

Algorithm 1 CLA: Context Latent Algorithm

Require: • N LQ - Natural Language Query •
DB_{S} - Database Schema Context
Ensure: Query Response to User

| | |
|---|---|
| 1: | {SubQ} ← Decompose NLQ into subqueries |
| 2: | for each sub query sqi ⊆ SubQ do |
| 3: | if sqi is related to Database then |
| 4: | SQLSubQ ← Generate SQL subquery |
| 5: | end if |
| 6: | if sqi is related to Policy Docs then |
| 7: | PolicySubQ ← Execute subquery on Graph RAG |
| 8: | end if |
| 9: | end for |
| 10: | for each SQLSubQi ⊆ SQLSubQ do |
| 11: | SQLData ← Execute SQLSubQi on Database |
| 12: | end for |
| 13: | for each PolicySubQi ⊆ PolicySubQ do |
| 14: | PolicyData ← Execute PolicySubQi on Graph RAG |
| 15: | end for |
| 16: | CombinedContext ← {SQLData ∪ PolicyData ∪ NLQ} |
| 17: | Final Query Response ← Give CombinedContext to LLM |

The Context Acute Approach (Algorithm 2) processes the one or more natural language queries (NLQ) by dynamically retrieving and integrating relevant context from unstructured and structured data sources. Initially, the NLQ is sent to the Graph RAG for similarity search, retrieving an initial context. This context, combined with the database schema, is passed to an LLM to assess whether additional database context is required. If needed, the LLM generates a SQL query, which is executed to fetch the relevant data. The retrieved database context, if available, is merged with the Graph RAG context. The combined context and the original NLQ are then sent to the LLM to generate the final response, ensuring context-sensitive query processing.

Algorithm 2 CAA: Context Acute Algorithm

| Require: • N LQ - Natural Language Query | |
|---|---|
| • DB_{S} - Database Schema Context | |
| Ensure: Final Query Response to User | |
| 1: | PolicyContext ← Execute NLQ on Graph RAG |
| 2: | Send PolicyContext and Database Schema Context to LLM |
| 3: | if Database context required then |
| 4: | SQLQuery ← LLM Generate SQL query. |
| 5: | SQLData ← Execute SQLQuery on Database |
| 6: | end if |
| 7: | CombinedContext ← {PolicyContext ∪ SQLData ∪ NLQ} |
| 8: | Final Query Response ← Give CombinedContext to LLM |

The Baseline Approach (Algorithm 3) also known as the brute force approach (known in the art) handles the one or more natural language queries (NLQ) by initially transforming it into an SQL query through the use of a Large Language Model (LLM). This SQL query is then executed on the database to retrieve the relevant data, referred to as SQLData. Simultaneously, the NLQ is processed through Graph RAG to extract policy-related information, which is labeled as PolicyData. Both SQLData and PolicyData along with the original NLQ, are combined to form a comprehensive context. Finally, this combined context is passed to a Large Language Model (LLM) to generate the query response. The Baseline Approach illustrates a vanilla approach (known in the art), where the query is need not decomposed for processing.

Experiment Setup: The efficacy of Baseline, Context Latent and Context Acute pipelines is validated by conducting an extensive experimental analysis. LLMs: In this study, the GPT-40-mini model (known in the art) is employed for generating chat completions. The GPT-40-mini model (known in the art) is deployed using the Microsoft Azure OpenAI Service® in the Japan East region and supports a context length of up to 128 k tokens. For generating word embeddings, the all-MiniLM-L6-v2 model (known in the art), sourced from the Hugging Face repository (known in the art), was utilized.

Knowledge Graph: The knowledge graph was constructed using the LLM-Graph-Builder tool provided by Neo4j (known in the art). The knowledge graph represents the policies of a banking institution and was developed using a dataset of eight policy documents in PDF format. The documents encompass various domains, including loan policies, account management, deposits, and general account rules. The data was processed and integrated into the graph structure to facilitate analysis and enable query resolution.

Prompt—Context Latent: The query decomposition prompt directs the model to analyze a user query, breaking it into subqueries that either utilize database data (via SQL joins across SQLite tables without modifying the database) or extract information from policy documents if a customer ID is absent. For generating the final response, the prompt instructs the LLM to synthesize the retrieved data, applying policy rules to generate a comprehensive response that incorporates both the policy context and any available customer-specific data.

Prompt—Context Acute: The SQL query generation prompt instructs the LLM to assess whether the query can be resolved solely using context from policy documents. If customer-specific data is required and a customer ID is available, it generates corresponding SQLite SQL queries; otherwise, it returns an empty list. The Final Answer Generation Prompt guides the LLM to produce a comprehensive response to the customer's natural language query by integrating policy context and any retrieved customer-specific information.

Data Sources: The experiments conducted were based on both structured and unstructured data. The structured data comprises tables containing customer and transaction information. The transaction table records transaction details such as amounts, balances, and types of transactions. The customer Table stores personal details, including date of birth, gender, and location. The loan Table provides information on loans, including loan amounts, statuses, grades, and customer income data. These tables form the backbone of structured data retrieval for query orchestration.

The unstructured data includes a collection of policy documents outlining various banking operations and policies. For instance, the Loan Policy document details loan types, eligibility, interest rates, and conditions such as collateral and penalties, while the Account Policy document specifies procedures for account registration and closure. Other key documents include the Grievance Policy document, which defines complaint resolution timelines, and the Know your customer (KYC)/anti-money laundering (AML) Policy document, which focuses on preventing financial crimes through risk assessment and identity verification. Additionally, the Data Privacy Policy document safeguards customer information, the Credit Risk Policy document addresses credit risk management, the Deposit Policy document outlines terms for deposit accounts, and the Fair Lending Policy document ensures non-discriminatory lending practices. These documents provide the contextual knowledge needed for unstructured data queries.

Bitext Retail Banking Chatbot Data (known in the art, for example, refer, “https://huggingface.co/datasets/bitext/Bitext-retail-banking-llm-chatbot-training-dataset”). The Bitext dataset (known in the art) is a retail banking corpus designed for chatbot applications, comprising 25,545 question-answer pairs. It spans a broad range of banking-related categories and intents, offering a robust resource for training conversational AI models. Each category addresses specific banking domains, with associated intents reflecting common customer queries and actions. For instance, the ACCOUNT category includes intents such as check-recent-transactions, close-account, and create-account, while the LOAN category covers intents like apply-for-loan, cancel-loan, and check-loan-payments. This structured dataset facilitates intent recognition and response generation, making it an essential tool for developing and evaluating chatbot systems in the banking sector.

In the present disclosure, 10 queries in the structured and unstructured format were taken for experiments. While taking 6 both structured and unstructured queries for experiments on pipelines.

Enterprise Data: The enterprise dataset originates from the banking domain and encompasses heterogeneous data. It includes structured data from an SQL database containing customer and transaction details, alongside unstructured data comprising policy documents on loans, KYCs, fixed deposits, and related topics. User queries may necessitate retrieving information from both structured and unstructured data sources. Some of the example queries will be found in Table 2. In the present disclosure, 5 queries are taken each for every intent for experiments on pipelines.

TABLE 1
Query Examples for each Intent
Table. 1 depicts query examples for each intent.

| Category | Intent | Query |
|---|---|---|
| LOAN | apply_for_loan | I am looking for a |
| | | loan, can you help |
| | | me find it? |
| | apply_for_mortgage | I would like to apply |
| | | for a mortgage, I |
| | | need help |
| | cancel_loan | I'd like to cancel a |
| | | loan, help me |
| | cancel_mortgage | I can't pay for my |
| | | mortgage, I'd like to |
| | | cancel it |
| | check_loan_payments | I'd like to see the loan |
| | | payments, I need |
| | | help |
| | check_mortgage_payments | I'd like to see the |
| | | mortgage payments, |
| | | help me |
| ACCOUNT | check_recent_transactions | I'd like to see the |
| | | current balance of my |
| | | account, I need |
| | | assistance |
| | close_account | Help me close a user |
| | | account |
| | create_account | I don't have a profile, |
| | | can you help me |
| | | create one? |

TABLE 2
Query Examples for each type
Table. 2 depicts query examples for each type.

| Category | Query |
|---|---|
| Structured only | What is my highest transaction amount, and |
| | what interest rate is applied to my loan? My |
| | customer id is C1010011 |
| Unstructured only | What is the process if I want to withdraw from my |
| | fixed deposit before it matures? |
| Unstructured & | Based on my credit score and existing debts, |
| Structured | can I increase my credit card limit? What are the |
| | risks involved, and how does it affect my credit |
| | risk profile? My CustomerID is C1010011 |

Ground Truth: The ground truth was established using a straightforward methodology in which all relevant data, including extracted database records, policy document content, and the user query, were provided directly to a large language model (LLM). The LLM generated a response, which was then verified and refined through human intervention to ensure accuracy.

The algorithm for generating ground truth begins by extracting structured data from the database and retrieving unstructured content from policy documents. This combined data, along with the user query, is fed into the LLM through a carefully designed prompt to generate a response. The generated response undergoes a thorough verification process: if the response is accurate, it is accepted as the ground truth. Otherwise, corrections are applied manually to ensure completeness and correctness. This iterative approach guarantees that the resulting ground truth aligns with both structured and unstructured data while addressing the user query comprehensively. The step-by-step procedure ensures robustness and reliability in establishing accurate ground truth for further evaluation.

Experiments: In the present disclosure, experiments using complex queries derived from the BiText dataset (known in the art, for example, refer, “https://huggingface.co/datasets/bitext/Bitext-retail-banking-llm-chatbot-training-dataset”). and a self-created Enterprise dataset were conducted. The queries were categorized into three types: (1) Those requiring access solely to structured data sources (2) Those relying exclusively on unstructured data sources (3) Those requiring a combination of structured and unstructured data sources.

Both datasets were executed on three query pipelines, and their responses were evaluated against the ground truth using metrics such as BERT scores (known in the art), encompassing precision (known in the art), recall (known in the art), and F1 score (known in the art). These metrics provided a comprehensive assessment of the accuracy and relevance of the responses from the all pipelines. Additionally, we analyzed the cost associated with Context Latent, Context Acute and Baseline pipelines across different query datasets, factoring in attributes such as intent and query type, to evaluate their efficiency.

### Example Use Case

### Context Latent Approach:

Query: Considering my employment length and income, am I eligible for a business loan of $50,000? What documentation will I need to provide? My CustomerID is C1010011
Intermediate Data:

The query decomposition module gives us the following output:

TABLE 3
Output of the query decomposition module.

```
[
  “ sub_query_1 ”: “ What is the employment
      length of the customer with ID
      C1010011 ?” ,
  “ sql_query ”: “SELECT CustomerEmpLength FROM
      LoanTable WHERE CustomerID = ‘
      C1010011 ’;”,
  “ sub_query_2 ”: “ What is the income of the
    customer with ID C1010011 ?”,
  “ sql_query ”: “ SELECT CustomerIncome FROM
    LoanTable WHERE CustomerID = ‘C1010011
    ’;”
  “ sub_query_3 ”: “ What documentation is
    required for a business loan
  of $50 ,000?” , “ sql_query ”: “”
]
```

Fetching Context from Structured/Unstructured data: Context from Database by running SQLs. Table. 4 depicts fetching context from structured/unstructured data.

TABLE 4
Fetching context from structured/unstructured data.

{“ CustomerEmpLength ”: 1.0 , “ CustomerIncome ”:
98000}

Table 5 depicts a similarity search-based context from unstructured data.

TABLE 5
Similarity search-based context from unstructured data.

```
[
    “ Chunk1 ”: “ and medium ... employed for at ” ,
    “ Chunk2 ”: “ - Personal ... loans may ”
    “ Chunk3 ”: “ least 3 years ... loan amount ”
  ]
```

Merge context to generate final response: In the final step the context obtained from both structured and unstructured data are merged to get the final query response. Table. 6 depicts the response for the given input query.

TABLE 6
Response to the given input query.

| Based on the provided context .. user data , | |
|---|---|
| | you are not eligible .. loan of $50 ,000 |
| Regarding documentation .... you need to | |
| | provide the following : |
| 1. | Proof of Identity : A government ... passport ) |
| 2. | Proof of Income : Salary slips ...3 months |
| 3. | Bank Statements : Bank account ... 6 months . |
| 4. | Collateral Documents: If applicable. |

### Context Acute

Query: Considering my employment length and income, am I eligible for a business loan of $50,000? What documentation will I need to provide? My CustomerID is C1010011
Context from Unstructured Data: In Context Acute method the initial query is sent to the Graph RAG to retrieve relevant context from unstructured data using similarity search as shown below in Table. 7.

TABLE 7
Context from Unstructured Data

```
[
  “ Chunk1 ”: “ and medium ... employed for at ” ,
  “ Chunk2 ”: “ - Personal ... loans may ”
  “ Chunk3 ”: “ least 3 years ... loan amount ”
]
```

SQL query generation: The context derived from unstructured data, the database schema, and a prompt instructing the LLM to generate SQL when necessary is provided to the LLM. The output of this step for the given query is depicted in the Table. 8.

TABLE 8
SQL query generation

```
sql_queries =[“ SELECT CustomerEmpLength ,
  CustomerIncome FROM LoanTable WHERE
  CustomerID = ‘C1010011 ’”]
```

Running SQL queries on Database: If an SQL query is generated then it is run on the database to get the context from the database. The output from the database is shown below:

TABLE 9
The output from the database.

{“ CustomerEmpLength ”: 1.0 , “ CustomerIncome ”:
98000}

Merge context to generate Final Output: In the final step the context obtained from both structured and unstructured data are merged to get the final response. For the given query the final response is given in the Table. 10:

TABLE 10
The final response after merging the
context to generate final output

Based on the provided information , you are

```
  currently employed for only 1 year ,
  while ... a business loan ....
```

Regarding the documentation .... provide the

| | |
|---|---|
| | following : |
| 1. | Proof of Identity : A government ... passport |
| 2. | Proof of Income : IT returns ... if employed . |
| 3. | Bank Statements : Bank account ...6 months . Unfortunately , since |

you do not meet the eligibility criteria ... free to ask !

In the present disclosure, the Context Latent, Context Acute and Baseline approaches are compared for various query types and intents across the Enterprise Dataset and Bitext Dataset to evaluate their impact on effectiveness, accuracy, and computational efficiency.

Enterprise Dataset—For queries requiring structured data, the Context Acute approach demonstrates superior cost-efficiency ($0.00037 USD vs. $0.00041 USD) while maintaining a slightly higher F1 Score (0.9219 vs. 0.9146) compared to Context Latent. Both approaches outperform the Baseline approach, which has the lowest F1 score (0.9092) and higher cost ($0.000503715). These queries rely solely on SQL data and require minimal complexity, making Context Acute favorable for these simpler query types.

For unstructured queries, Context Latent outperforms both Context Acute and Baseline in F1 Score (0.9106 vs. 0.9049 and 0.8989, respectively) while maintaining a competitive cost at $0.00043, which is lower than Context Acute's $0.00061 and Baseline's $0.00044. The Context acute shines here due to its ability to manage more complex unstructured data, leading to a higher accuracy despite a marginally higher cost than Context Latent.

For hybrid queries involving both structured and unstructured data, Context Acute offers the lowest cost ($0.00051 USD vs. $0.00085 USD for Context Latent) but at a slight reduction in F1 Score (0.8825 vs. 0.9065). Baseline again performs the worst with an even lower F1 score (0.859) and cost slightly above the Context Acute model ($0.00059). The inclusion of both data types adds complexity, where Context Latent involves higher token usage for sub-query decomposition but provides better accuracy.

BiText Dataset: In the loan-related intents, Context Acute generally provides better cost-efficiency and slightly higher F1 Scores compared to the baseline. For example, in the apply-for-loan intent, Context Acute achieves an F1 Score of 0.8588 at 0.0005 USD, outperforming Context Latent's 0.8501 F1 Score at 0.000541 USD, and the baseline's 0.8505 F1 Score at 0.00063 USD. Similar trends are observed for apply-for-mortgage and cancel-mortgage. For transaction-related queries like check-recent-transactions, Context Latent achieves better cost efficiency (0.0002281 USD vs. 0.00042 USD) with a higher F1 Score (0.8953 vs. 0.8866), compared to the baseline's 0.8675 F1 Score at 0.00044421 USD. These queries are simple, and the lack of need for complex sub-query generation favors the Context Latent approach.

In account-related queries, the performance varies. For close-account, Context Acute improves F1 Score (0.8867 vs. 0.8681) but at a higher cost (0.00049 USD vs. 0.00035 USD), compared to the baseline's 0.8773 F1 Score at 0.00050274 USD. In contrast, for create-account, Context Acute reduces costs (0.00055 USD vs. 0.000671 USD) while maintaining comparable accuracy to the baseline's 0.8859 F1 Score at 0.00066654 USD.

The choice between Baseline, Context Latent, and Context Acute depends on query complexity and data type. For simple, structured queries like check-recent-transactions, Context Latent is more efficient, achieving a higher F1 Score (0.8953 vs. 0.8866) and better cost efficiency (0.0002281 USD vs. 0.00042 USD) compared to Context Acute. However, Context Acute outperforms Context Latent and the Baseline in unstructured queries such as apply-for-loan, where it achieves an F1 Score of 0.8588 at 0.0005 USD, slightly better than Context Latent's 0.8501 F1 Score at 0.000541 USD and the Baseline's 0.8505 F1 Score at 0.00063 USD. For hybrid queries like cancel-mortgage, Context Acute again delivers better accuracy (0.8905 vs. 0.8723 for Context Latent) and performs similarly or more efficiently than the Baseline (0.8754 F1 Score at 0.00050847 USD). Table. 11 depicts Context Latent Versus Context Acute Versus Baseline Performance Metrics.

TABLE 11
Context Latent Vs Context Acute Vs Baseline Performance Metrics

| | | | Context Latent | | Context Acute | | Baseline | |
|---|---|---|---|---|---|---|---|---|
| | | | Average | Average | Average | Average | Average | Average |
| Type Of | Query | | f1 | Cost | f1 | Cost | f1 | Cost |
| Data set | Category | Intent | Score | (USD) | Score | (USD) | Score | (USD) |
| Enterprise | Structured | NA | 0.9219 | 0.00037 | 0.9146 | 0.00041 | 0.9092 | 0.00050 |
| Data | Only | | | | | | | |
| | Unstructured | NA | 0.9049 | 0.00061 | 0.9106 | 0.00043 | 0.8989 | 0.00044 |
| | Only | | | | | | | |
| | Structured & | NA | 0.9065 | 0.00085 | 0.8825 | 0.00051 | 0.859 | 0.00059 |
| | Unstructured | | | | | | | |
| Bitext | Loan | apply_for_loan | 0.8501 | 0.000541 | 0.8588 | 0.0005 | 0.8505 | 0.00063 |
| Data | | apply_for_mortgage | 0.8614 | 0.000569 | 0.8678 | 0.000512 | 0.8428 | 0.00057159 |
| | | cancel_loan | 0.8649 | 0.000464 | 0.8991 | 0.000492 | 0.8662 | 0.00054378 |
| | | cancel_mortgage | 0.8723 | 0.000504 | 0.8905 | 0.000489 | 0.8754 | 0.00050847 |
| | | check_loan_payments | 0.8584 | 0.000329 | 0.8372 | 0.000429 | 0.8501 | 0.00047202 |
| | | check_mortgage_payments | 0.8583 | 0.000327 | 0.8729 | 0.000452 | 0.8449 | 0.00056367 |
| | Account | check_recent_transactions | 0.8953 | 0.0002281 | 0.8866 | 0.00042 | 0.8675 | 0.00044421 |
| | | close_account | 0.8681 | 0.00035 | 0.8867 | 0.00049 | 0.8773 | 0.00050274 |
| | | create_account | 0.891 | 0.00067 | 0.8899 | 0.00055 | 0.8859 | 0.00066654 |

The findings reveal the trade-offs between cost and performance, with Context Latent performing well on structured queries, while Context Acute is better for complex, unstructured, and hybrid queries due to optimized token usage and similar or improved accuracy. Further comparisons with the Baseline are available in Tables 12, 13, and 14 respectively.

TABLE 12
Comparison of Baseline, Context Latent, and
Context Acute Models for Different Data Types

| Data Type | Analysis |
|---|---|
| Structured Only | Context Latent: F1 Score: 0.9219, |
| | Cost: 0.00037 USD. Context Acute: |
| | F1 Score: 0.9146, Cost: 0.00041 |
| | USD. Baseline: F1 Score: 0.9092, |
| | Cost: 0.0005037 USD. |
| | Detailed Analysis: |
| | The cost rises slightly from |
| | 0.00037 USD (Context Latent) to |
| | 0.00041 USD (Context Acute), with |
| | both approaches maintaining similar |
| | F1 Scores. Context Latent is more |
| | cost-efficient than Context Acute, |
| | while both outperform the Baseline |
| | in terms of cost and performance. |
| | Context Latent: F1 Score: 0.8149, |
| | Cost: 0.00061 USD. Context Acute: |
| | F1 Score: 0.9106, Cost: 0.00043 |
| | USD. Baseline: F1 Score: 0.8989, |
| | Cost: 0.00044 USD. |
| | Detailed Analysis: |
| | The cost decreases significantly |
| | from 0.00061 USD (Context Latent) |
| | to 0.00043 USD (Context Acute), |
| | showing that Context Acute is more |
| | efficient for unstructured queries. It |
| | also outperforms both Context |
| | Latent and the Baseline in terms of |
| | F1 Score, making it the better choice |
| | for unstructured data. |
| | Context Latent: F1 Score: 0.9065, |
| | Cost: 0.00085 USD. Context Acute: |
| | F1 Score: 0.8825, Cost: 0.00051 |
| | USD. Baseline: F1 Score: 0.859, |
| | Cost: 0.0005989 USD. |
| | Detailed Analysis: |
| | The cost decreases from 0.00085 |
| | USD (Context Latent) to 0.00051 |
| | USD (Context Acute), showing that |
| | the Context Acute model is more |
| | cost-efficient for mixed data types, |
| | while providing slightly lower |
| | accuracy than Context Latent. Both |
| | approaches outperform the Baseline |
| | in terms of cost, with Context Latent |
| | providing the highest F1 Score in |
| | this category. |

TABLE 13
Comparison of Baseline, Context Latent, and
Context Acute Models for Loan-Related Queries

| Intent | Analysis |
|---|---|
| apply_for_loan | Context Latent: F1 Score: 0.8501, |
| | Cost: 0.000541 USD. Context |
| | Acute: F1 Score: 0.8588, Cost: |
| | 0.0005 USD. Baseline: F1 Score: |
| | 0.8505, Cost: 0.00063 USD. |
| | Detailed Analysis: |
| | The cost decreases from 0.000541 |
| | USD (Context Latent) to 0.0005 |
| | USD (Context Acute), indicating that |
| | Context Acute is more cost-efficient. |
| | Both Context Latent and Context |
| | Acute outperform the Baseline in |
| | cost and performance, with Context |
| | Acute achieving the highest F1 |
| | Score. |
| apply_for_mortgage | Context Latent: F1 Score: 0.8614, |
| | Cost: 0.000569 USD. Context |
| | Acute: F1 Score: 0.8678, Cost: |
| | 0.000512 USD. Baseline: F1 Score: |
| | 0.8428, Cost: 0.0005716 USD. |
| | Detailed Analysis: |
| | The cost decreases from 0.000569 |
| | USD (Context Latent) to 0.000512 |
| | USD (Context Acute), and both |
| | outperform the Baseline in terms of |
| | F1 Score and cost. Context Acute |
| | provides the highest F1 Score and is |
| | more cost-efficient. |
| cancel_loan | Context Latent: F1 Score: 0.8649, |
| | Cost: 0.000464 USD. Context |
| | Acute: F1 Score: 0.8991, Cost: |
| | 0.000492 USD. Baseline: F1 Score: |
| | 0.8662, Cost: 0.0005438 USD. |
| | Detailed Analysis: |
| | The cost increases slightly from |
| | 0.000464 USD (Context Latent) to |
| | 0.000492 USD (Context Acute). |
| | Despite this increase, Context Acute |
| | outperforms both Context Latent and |
| | the Baseline in terms of F1 Score, |
| | making it the better choice for |
| | performance. |
| cancel_mortgage | Context Latent: F1 Score: 0.8723, |
| | Cost: 0.000504 USD. Context |
| | Acute: F1 Score: 0.8905, Cost: |
| | 0.000489 USD. Baseline: F1 Score: |
| | 0.8754, Cost: 0.0005085 USD. |
| | Detailed Analysis: |
| | The cost slightly decreases from |
| | 0.000504 USD (Context Latent) to |
| | 0.000489 USD (Context Acute), and |
| | both outperform the Baseline in |
| | terms of F1 Score and cost. Context |
| | Acute offers the best performance |
| | with the lowest cost. |
| check_loan_payments | Context Latent: F1 Score: 0.8584, |
| | Cost: 0.000329 USD. Context |
| | Acute: F1 Score: 0.8372, Cost: |
| | 0.000429 USD. Baseline: |
| | F1 Score: 0.8501, Cost: 0.000472 |
| | USD. |
| | Detailed Analysis: |
| | The cost increases from 0.000329 |
| | USD (Context Latent) to 0.000429 |
| | USD (Context Acute), reflecting the |
| | additional processing cost incurred |
| | by the context-sensitive model, |
| | despite the drop in performance. |
| | Context Latent offers the best |
| | balance between cost and |
| | performance, outperforming both |
| | Context Acute and the Baseline in |
| | terms of F1 Score. |
| check_mortgage_payments | Context Latent: F1 Score: 0.8583, |
| | Cost: 0.000327 USD. Context |
| | Acute: F1 Score: 0.8729, Cost: |
| | 0.000452 USD. Baseline: F1 Score: |
| | 0.8449, Cost: 0.0005637 USD. |
| | Detailed Analysis: |
| | The cost increases from 0.000327 |
| | USD (Context Latent) to 0.000452 |
| | USD (Context Acute), indicating the |
| | higher computational expense of |
| | context-sensitive models, though the |
| | performance improvement justifies |
| | this increase. Both Context Latent |
| | and Context Acute outperform the |
| | Baseline in terms of F1 Score and |
| | cost. |

TABLE 14
Comparison of Baseline, Context Latent, and
Context Acute Models for Account Queries

| Intent | Analysis |
|---|---|
| check_recent_transactions | Context Latent: F1 Score: 0.8953, |
| | Cost: 0.0002281 USD. Context |
| | Acute: F1 Score: 0.8866, Cost: |
| | 0.00042 USD. Baseline: F1 Score: |
| | 0.8675, Cost: 0.0004442 USD. |
| | Detailed Analysis: |
| | The cost increases from |
| | 0.0002281 USD (Context Latent) to |
| | 0.00042 USD (Context Acute). While |
| | both Context Latent and Context |
| | Acute outperform the Baseline in |
| | terms of F1 Score, the Context |
| | Latent model is more cost-efficient. |
| | For simple transaction-related |
| | queries, Context Latent offers the |
| | best balance of cost and |
| | performance. |
| close_account | Context Latent: F1 Score: 0.8681, |
| | Cost: 0.00035 USD. Context Acute: |
| | F1 Score: 0.8867, Cost: 0.00049 |
| | USD. Baseline: F1 Score: 0.8773, |
| | Cost: 0.0005027 USD. |
| | Detailed Analysis: |
| | The cost increases from 0.00035 |
| | USD (Context Latent) to 0.00049 |
| | USD (Context Acute), while both |
| | models show a moderate increase in |
| | cost compared to the Baseline. |
| | However, the improvement in F1 |
| | Score justifies the higher cost for |
| | Context Acute. Context Latent is still |
| | competitive but may not provide the |
| | same level of performance as |
| | Context Acute in this case. |
| create_account | Context Latent: F1 Score: 0.891, |
| | Cost: 0.000671 USD. Context |
| | Acute: F1 Score: 0.8899, Cost: |
| | 0.00055 USD. Baseline: F1 Score: |
| | 0.8859, Cost: 0.0006665 USD. |
| | Detailed Analysis: |
| | The cost decreases from |
| | 0.000671 USD (Context Latent) to |
| | 0.00055 USD (Context Acute), |
| | showing that Context Acute is more |
| | cost-efficient. While Context Latent |
| | has a slightly higher F1 Score, |
| | Context Acute provides comparable |
| | performance at a lower cost. Both |
| | models outperform the Baseline in |
| | terms of cost and performance, with |
| | Context Acute being the better |
| | choice for this intent. |

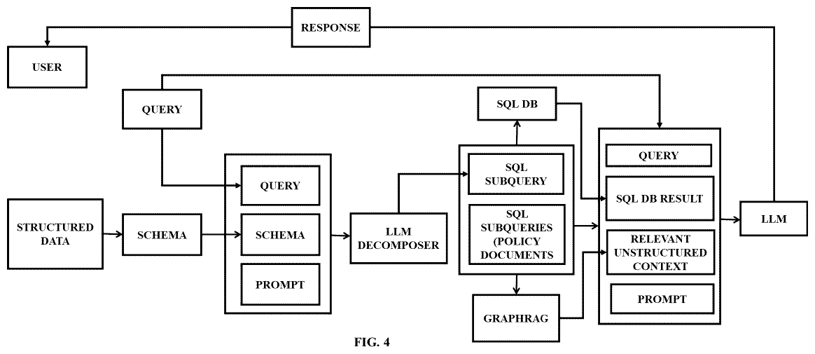

FIG. 4 is a block diagram illustrating a context latent approach, in conjunction with the method for hybrid query orchestration for complex queries, according to some embodiments of the present disclosure.

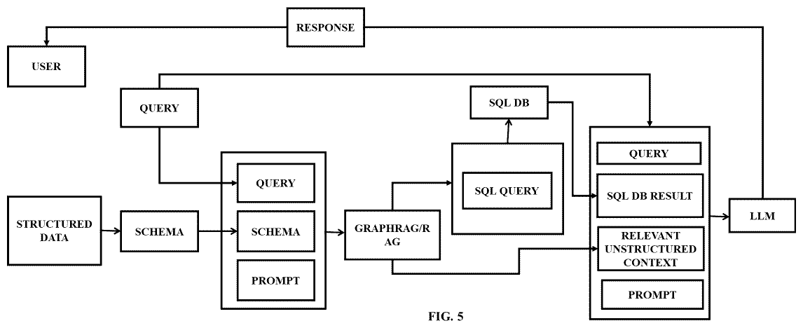

FIG. 5 is a block diagram illustrating a context acute approach, in conjunction with the method for hybrid query orchestration for complex queries, according to some embodiments of the present disclosure.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The chatbot-based banking query orchestration system 100 addresses customer queries efficiently using structured data from comma-separated values (CSV) files and unstructured data from policy documents. The system 100 leverages two pipelines to process these data sources, enabling the chatbot (known in the art) to generate accurate and informative responses. By providing accurate and timely answers, the system 100 improves customer satisfaction and reduces the workload on human agents. In this context, actors or the entities who interact with a system (for e.g., chatbot) include customers seeking information or solutions to banking queries, the chatbot intelligently queries databases and generate responses using both structured and unstructured data, and the banking data itself, comprising structured CSV files and unstructured policy documents.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, comprising:
receiving, via one or more hardware processors, an input comprising (i) one or more natural language queries (NLQ) from a user; and (ii) one or more database schema contexts associated with the one or more NLQ from one or more structured data sources and one or more unstructured data sources;
generating, via the one or more hardware processors, a prompt using the received input;
decomposing, via the one or more hardware processors, the received one or more NLQ into one or more subqueries by sending the generated prompt to one or more Large Language Models (LLMs);
converting, via the one or more hardware processors, the one or more subqueries into a first set of Structured Query Language (SQL) queries, if the one or more subqueries contain information specific to a database;
converting, via the one or more hardware processors, the one or more subqueries into a first set of subqueries, if the one or more subqueries contain information specific to one or more documents;
retrieving, via the one or more hardware processors, a first set of data pertaining to the first set of SQL queries comprised in the database by executing the first set of SQL queries on the database;
retrieving, via the one or more hardware processors, a context pertaining to the first set of subqueries, by executing the first set of subqueries on a Graph RAG (Retrieval Augmented Generation);
combining, via the one or more hardware processors, (i) the retrieved first set of data pertaining to the first set of SQL queries, (ii) the retrieved context pertaining to the first set of subqueries along with the received one or more NLQ; and
generating, via the one or more hardware processors, a response for the user by sending the combined data comprising (i) the retrieved first set of data pertaining to the first set of SQL queries, (ii) the retrieved context pertaining to the first set of subqueries along with the received one or more NLQ to the one or more LLMs.

2. The processor implemented method of claim 1, wherein the context pertaining to the one or more documents retrieved along with the one or more database schema contexts for processing by the one or more LLMs to determine whether an additional database context is required, and wherein in the event that the additional database context is required, method comprises:
a) generating a second set of SQL queries by the one or more LLMs, if the additional database context is required;
b) retrieving a second set of data from the database by executing the generated second set of SQL queries;
c) combining (i) the retrieved context pertaining to the one or more documents (ii) the retrieved second set of data along with the received one or more NLQ; and
d) generating the response to the user by sending the combined data comprising (i) the retrieved context pertaining to the one or more documents (ii) the retrieved second set of data along with the received one or more NLQ.

3. The processor implemented method of claim 1, wherein the one or more structured data sources comprises at least one of one or more databases storing customer information and one or more transaction details.

4. The processor implemented method of claim 1, wherein the one or more unstructured data sources comprise to the one or more documents which are stored in a Portable Document Format (PDF) format.

5. The processor implemented method of claim 1, wherein the one or more documents comprise policy related information specific to a financial institution stored in an unstructured format.

6. The processor implemented method of claim 1, wherein the first set of data comprises one or more SQL results in response to the first set of SQL queries.

7. The processor implemented method of claim 1, wherein the additional database context comprises a schema of the database.

8. The processor implemented method of claim 1, wherein the second set of data comprises one or more SQL results in response to the second set of SQL queries.

9. A system, comprising:
a memory storing instructions;
one or more communication interfaces; and
one or more hardware processors coupled to the memory via the one or more communication interfaces, wherein the one or more hardware processors are configured by the instructions to:
receive an input comprising (i) one or more natural language queries (NLQ) from a user; and (ii) one or more database schema contexts associated with the one or more NLQ from one or more structured data sources and one or more unstructured data sources;
generate a prompt using the received input;
decompose the received one or more NLQ into one or more subqueries by sending the generated prompt to one or more Large Language Models (LLMs);
convert the one or more subqueries into a first set of Structured Query Language (SQL) queries, if the one or more subqueries contain information specific to a database;
convert the one or more subqueries into a first set of subqueries, if the one or more subqueries contain information specific to one or more documents;
retrieve a first set of data pertaining to the first set of SQL queries comprised in the database by executing the first set of SQL queries on the database;
retrieve a context pertaining to the first set of subqueries, by executing the first set of subqueries on a Graph RAG (Retrieval Augmented Generation);
combine (i) the retrieved first set of data pertaining to the first set of SQL queries, (ii) the retrieved context pertaining to the first set of subqueries along with the received one or more NLQ; and
generate a response for the user by sending the combined data comprising (i) the retrieved first set of data pertaining to the first set of SQL queries, (ii) the retrieved context pertaining to the first set of subqueries along with the received one or more NLQ to the one or more LLMs.

10. The system of claim 9, wherein the context pertaining to the one or more documents retrieved along with the one or more database schema contexts for processing by the one or more LLMs to determine whether an additional database context is required, and wherein in the event that the additional database context is required, method comprises:
a) generating a second set of SQL queries by the one or more LLMs, if the additional database context is required;
b) retrieving a second set of data from the database by executing the generated second set of SQL queries;
c) combining (i) the retrieved context pertaining to the one or more documents (ii) the retrieved second set of data along with the received one or more NLQ; and
d) generating the response to the user by sending the combined data comprising (i) the retrieved context pertaining to the one or more documents (ii) the retrieved second set of data along with the received one or more NLQ.

11. The system of claim 9, wherein the one or more structured data sources comprises at least one of one or more databases storing customer information and one or more transaction details.

12. The system of claim 9, wherein the one or more unstructured data sources comprises the one or more documents which are stored in a Portable Document Format (PDF) format.

13. The system of claim 9, wherein the one or more documents comprises policy related information specific to a bank stored in an unstructured format.

14. The system of claim 9, wherein the first set of data comprises one or more SQL results in response to the first set of SQL queries.

15. The system of claim 9, wherein the additional database context comprises a schema of the database.

16. The system of claim 9, wherein the second set of data comprises one or more SQL results in response to the second set of SQL queries.

17. One or more non-transitory machine-readable information storage mediums comprising one or more instructions which when executed by one or more hardware processors cause:
receiving an input comprising (i) one or more natural language queries (NLQ) from a user; and (ii) one or more database schema contexts associated with the one or more NLQ from one or more structured data sources and one or more unstructured data sources;
generating a prompt using the received input;
decomposing the received one or more NLQ into one or more subqueries by sending the generated prompt to one or more Large Language Models (LLMs);
converting the one or more subqueries into a first set of Structured Query Language (SQL) queries, if the one or more subqueries contain information specific to a database;
converting the one or more subqueries into a first set of subqueries, if the one or more subqueries contain information specific to one or more documents;
retrieving a first set of data pertaining to the first set of SQL queries comprised in the database by executing the first set of SQL queries on the database;
retrieving a context pertaining to the first set of subqueries, by executing the first set of subqueries on a Graph RAG (Retrieval Augmented Generation);
combining (i) the retrieved first set of data pertaining to the first set of SQL queries, (ii) the retrieved context pertaining to the first set of subqueries along with the received one or more NLQ; and
generating a response for the user by sending the combined data comprising (i) the retrieved first set of data pertaining to the first set of SQL queries, (ii) the retrieved context pertaining to the first set of subqueries along with the received one or more NLQ to the one or more LLMs.

18. The one or more non-transitory machine readable information storage mediums of claim 17, wherein the context pertaining to the one or more documents retrieved along with the one or more database schema contexts for processing by the one or more LLMs to determine whether an additional database context is required, and wherein in the event that the additional database context is required, method comprises:
a) generating a second set of SQL queries by the one or more LLMs, if the additional database context is required;
b) retrieving a second set of data from the database by executing the generated second set of SQL queries;
c) combining (i) the retrieved context pertaining to the one or more documents (ii) the retrieved second set of data along with the received one or more NLQ; and
d) generating the response to the user by sending the combined data comprising (i) the retrieved context pertaining to the one or more documents (ii) the retrieved second set of data along with the received one or more NLQ.

19. The one or more non-transitory machine readable information storage mediums of claim 17, wherein the one or more structured data sources comprises at least one of one or more databases storing customer information and one or more transaction details.

20. The one or more non-transitory machine readable information storage mediums of claim 17, wherein the one or more unstructured data sources comprise to the one or more documents which are stored in a Portable Document Format (PDF) format, wherein the one or more documents comprise policy related information specific to a financial institution stored in an unstructured format, wherein the first set of data comprises one or more SQL results in response to the first set of SQL queries, wherein the additional database context comprises a schema of the database, and wherein the second set of data comprises one or more SQL results in response to the second set of SQL queries.
